(19) United States
(12) Patent Application Publication
(10) Pub. No.: US 2024/0332885 A1
(43) Pub. Date: Oct. 3, 2024

(54) HYBRID LOCKING ELECTRONICS FOR HIGH-SPEED, HIGH-PRECISION LOCKS TO ULTRA-STABLE HIGH FINESSE CAVITIES

(71) Applicant: Stable Laser Systems, Inc., Boulder, CO (US)

(72) Inventors: William David LEE, Boulder, CO (US); Josue DAVILA-RODRIGUEZ, Boulder, CO (US); Tyko SHOJI, Boulder, CO (US); Mark NOTCUTT, Boulder, CO (US)

(73) Assignee: Stable Laser Systems, Inc., Boulder, CO (US)

(21) Appl. No.: 18/623,631

(22) Filed: Apr. 1, 2024

Related U.S. Application Data
(60) Provisional application No. 63/493,953, filed on Apr. 3, 2023.

(51) Int. Cl. H01S 3/13; H01S 3/10

(52) U.S. Cl. CPC H01S 3/1305; H01S 3/10053

(57) ABSTRACT

A laser stabilization system for stabilizing a laser beam emitted by a laser includes a phase modulator configured to apply a phase modulation to received laser radiation, an optical cavity configured to receive the phase modulated laser radiation and provide amplitude modulated measurement radiation, and an optical detector configured to generate, based on the amplitude modulated measurement radiation, a radiofrequency electrical signal. A signal distribution network provides a digital branch electrical input signal and an analog branch electrical input signal to a digital control circuit and an analog control circuit, respectively. The digital control circuit generates, based on the digital branch electrical input signal, a first control signal, and the analog control circuit generates, based on the analog branch electrical input signal, a second control signal. An output interface supplies laser control output to the laser based on the first control signal and the second control signal.

### CROSS-REFERENCE TO RELATED APPLICATIONS

This application claims the benefit of priority to U.S. Provisional Patent Application No. 63/493,953, filed Apr. 3, 2023, which is hereby incorporated by reference in its entirety.

### STATEMENT REGARDING FEDERALLY SPONSORED RESEARCH OR DEVELOPMENT

The subject matter of the present disclosure was developed using funding provided under Air Force Small Business Technology Transfer (STTR) Contract No. FA864921P0952.

### FIELD

The present disclosure relates generally to laser frequency stabilization, and in particular, to laser frequency stabilization via the Pound-Drever-Hall (PDH) technique.

### BACKGROUND

The free-running frequency stability of a typical laser is insufficient for many applications from spectroscopy to timekeeping and time transfer. Accordingly, active laser frequency stabilization is necessary to achieve the frequency stability required for these and other high-precision laser applications. One such technique for active frequency stabilization entails locking the laser to a longitudinal mode of a high quality optical resonator (e.g. a Fabry-Perot cavity) via the Pound-Drever-Hall (PDH) technique.

### SUMMARY

In an embodiment, the present disclosure provides a laser stabilization system for stabilizing a laser beam emitted by a laser at a target frequency. The laser stabilization system includes a phase modulator configured to receive laser radiation provided by the laser, to apply a phase modulation to the received laser radiation, and to provide, as output, phase modulated laser radiation. The laser stabilization system also includes an optical cavity configured to receive the phase modulated laser radiation and to provide amplitude modulated measurement radiation, and an optical detector configured to receive the amplitude modulated measurement radiation from the optical cavity and to generate, based on the received amplitude modulated measurement radiation, a radiofrequency electrical signal. The laser stabilization system additionally includes a signal distribution network configured to receive the radiofrequency electrical signal and to provide, based on the radiofrequency electrical signal, a digital branch electrical input signal and an analog branch electrical input signal. The laser stabilization system further includes a digital control circuit configured to receive the digital branch electrical input signal and to generate, based on the digital branch electrical input signal, a first control signal, and an analog control circuit configured to receive the analog branch electrical input signal and to generate, based on the analog branch electrical input signal, a second control signal. In addition, the laser stabilization system includes an output interface configured to supply laser control output to the laser based on the first control signal and the second control signal.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a prior art Pound-Drever-Hall (PDH) laser frequency stabilization system that utilizes analog circuitry to process a feedback signal and generate a control signal for stabilizing the frequency of a laser beam;

FIG. 2 illustrates a PDH laser frequency stabilization system that utilizes digital circuitry to process a feedback signal and generate a control signal for stabilizing the frequency of a laser beam;

FIGS. 3A through 3E illustrate general architectures for a PDH laser frequency stabilization system, which includes a digital control branch and an analog control branch, that utilizes hybrid circuitry to process a feedback signal and generate control signals for stabilizing the output frequency of a laser beam, and different actuator control configurations for actuating various actuators of a laser system provided as a component of the general architectures;

FIGS. 4A through 4D illustrate, in the form of amplitude vs. frequency plots, phase modulated laser light signals produced in various operation modes of a PDH laser frequency stabilization system that utilizes hybrid circuitry to process a feedback signal and generate control signals for stabilizing the output frequency of a laser beam;

FIGS. 5A through 5D illustrate digital circuitry suitable for use as digital locking electronics of a hybrid PDH laser frequency stabilization system constructed according to one of the general architectures provided in FIGS. 3A through 3E;

FIG. 6 illustrates a general architecture for a PDH laser frequency stabilization system, which includes a digital control branch and an analog control branch, that utilizes hybrid circuitry to process a feedback signal and generate control signals for stabilizing the output frequency of a laser beam; and

FIG. 7 provides a comparison of (i) a laser noise output spectrum of a laser that is frequency stabilized by a digital PDH laser frequency stabilization system and (ii) a laser noise output spectrum of a laser that is frequency stabilized by a hybrid PDH laser frequency stabilization system according to an embodiment of the disclosure.

### DETAILED DESCRIPTION

### Analog PDH Feedback Control

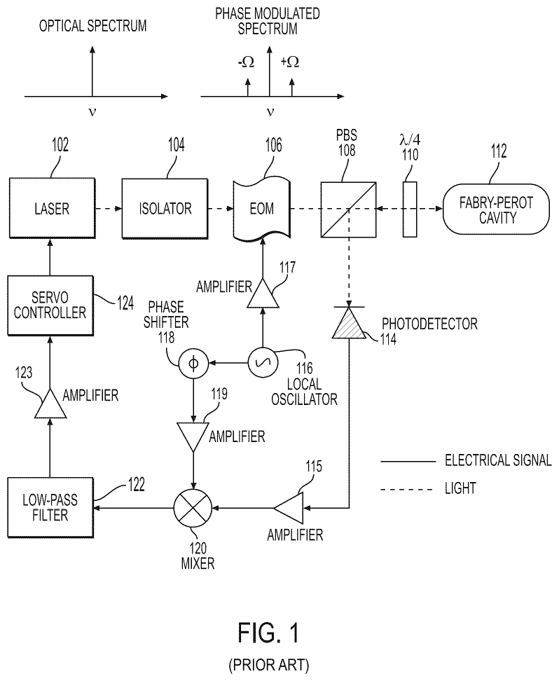

Until recently, laser frequency stabilization via the Pound-Drever-Hall (PDH) technique has relied on analog control circuits. Such analog circuits utilize, for example, double-balanced mixers, operational amplifiers, etc. FIG. 1 illustrates a PDH laser frequency stabilization system 100 that utilizes analog circuitry to process a feedback signal and generate a control signal for stabilizing the frequency of a laser beam. In the illustrated schematic, servo 124 comprises control electronics that utilize feedback, in the form of an electrical PDH error signal provided by mixer 120, to provide for control of the laser 102. Specifically, the servo 124 controls an actuator of the laser 102 so as to stabilize the optical frequency of the emitted beam close to the resonant center frequency of a reference cavity, i.e. the Fabry-Perot cavity 112. Suitable reference cavities for many applications include Fabry-Perot cavities made with high-stability material spacers such as ultra-low expansion (ULE)™ glass and/or crystalline materials (e.g., silicon or sapphire operated at cryogenic temperature; low creep ceramics such as NEXCERA™).

The PDH laser frequency stabilization system 100 is configured to perform a PDH technique to stabilize an optical frequency of laser 102. As illustrated, the PDH laser frequency stabilization system 100 further includes: an isolator 104, an electro-optic modulator (EOM) 106, a polarizing beam splitter (PBS) 108, a quarter-wave plate 110, a Fabry-Perot cavity 112, a photodetector 114, an amplifier 115, a Local Oscillator (LO) 116, an amplifier 117, a phase shifter 118, an amplifier 119, a mixer 120, a low pass filter (LPF) 122, an amplifier 123, and a servo controller 124.

In operation, the laser 102 of the PDH laser frequency stabilization system 100 emits a laser beam consisting primarily of electromagnetic radiation at an optical frequency of v. The laser beam passes through the isolator 104 before arriving at the EOM 106. While not necessary for performing the PDH technique, the isolator 104 is provided to prevent electromagnetic radiation reflected from downstream components of the laser frequency stabilization system from returning to a lasing cavity of the laser 102.

The EOM 106 receives a drive signal from the amplifier 117 at frequency Ω from the LO 116 and phase modulates the laser light signal to produce optical sidebands at v+/−Ω. The phase modulated laser light signal is incident on the Fabry-Perot cavity 112, where Ω is assumed to be larger than the resonance width of the Fabry-Perot cavity 112. When the phase modulated laser light signal is reflected from the Fabry-Perot cavity 112, the laser light that coincides with a cavity resonance (carrier or sideband) will undergo a phase shift with respect to those portions that are non-resonant. In this manner, the reflected light is no longer purely phase modulated, but exhibits amplitude modulation at the frequency Ω.

In the laser frequency stabilization system 100 of FIG. 1, the reflected portion of the phase modulated laser light signal, which exhibits amplitude modulation at the frequency Ω, (i.e. the amplitude modulated light) is sent to the photodetector 114 through the PBS 108 and the quarter-wave plate 110. Other equipment configurations prior to the photodetector 114 are also possible (e.g., a circulator, a beam splitter, etc.). The photodetector 114 detects the amplitude modulation of the amplitude modulated light and generates an electrical signal therefrom. The electrical signal is then conditioned by the amplifier 115 and synchronously demodulated by the mixer 120 using the LO 116 frequency Q to obtain a demodulated electrical signal at baseband.

The amplitude modulated light exhibits amplitude modulation at the frequency Ω, i.e. the same frequency at which the LO 116 is driven. A specific phase difference between the LO 116 and the amplitude modulated light when the laser beam is exactly at the resonance center frequency is desired to optimize the error signal slope/gradient to give the maximum sensitivity to the laser's frequency noise. The static configuration of the signal paths may not initially provide the required demodulation phase difference. Accordingly, a tunable phase shifter 118 is set to create the required phase relationship by providing its phase shift signal to amplifier 119 for conditioning the signal for the mixer 120.

After demodulation at the mixer 120, the demodulated electrical signal is filtered at the low pass filter 122 to attenuate components in the demodulated signal higher than a feedback bandwidth and thereby obtain an error signal usable for tuning the optical frequency v of the laser 102. In particular, the second harmonic of the modulation frequency, a byproduct of the mixing process, is strongly filtered, as its presence can lead to offsets at the input of any amplifier or subsequent circuit or signal processing chain exhibiting nonlinearities. In an ideal state, the error signal is a voltage that is strictly proportional to an instantaneous frequency difference between the laser and the center resonant frequency of the Fabry-Perot cavity 112.

Thereafter, the error signal is conditioned by amplifier 123 and provided to the servo controller 124, which is connected to a frequency control actuator of the laser 102. In this manner, the servo controller 124 controls a frequency control actuator of the laser 102 to tune the optical frequency v of the laser 102 based on the error signal. The servo controller 124 may be, e.g., a Proportional-Integral-Derivative (PID) servo controller.

A PDH feedback control implementation that relies on analog circuitry, such as the laser frequency stabilization system 100 of FIG. 1, exhibits certain limitations. First, imperfect phase modulation can cause the error signal to shift vertically, resulting in an error signal value that deviates from 0 V at the resonance center frequency. This can lead to a systematic shift in the frequency of the output laser beam, and this shift may exhibit instability and variation over time. In order to mitigate potential errors introduced by imperfect phase modulation, low residual amplitude modulation (RAM) modulators and/or actively cancelling RAM can be used.

Second, analog mixers can introduce voltage offsets at their output, thereby presenting another potential source of systematic shifts in the frequency of the output laser beam. The voltage offsets introduced by analog mixers are of a variable nature as they depend on, inter alia, input power and mixer temperature and may drift with time due to unknown and poorly controlled experimental parameters. Analog mixers can also exhibit aging. For example, with reference to the laser frequency stabilization system 100 of FIG. 1, the analog mixer 120 introduces certain non-idealities when demodulating the RF in with the signal from the LO 116. These non-idealities are caused by the multiplication being performed in analog form, which is susceptible to changes in the environment such as the device temperature and other factors that cause drift in the output of the mixer 120. Similarly, both the low pass filter 122 and the servo 124 may require pre-amplifiers (not illustrated in FIG. 1), which are also potential sources of time varying bias. Any drift in an amplifier's DC offset is indistinguishable from the true error signal and leads to degraded laser stability.

Third, amplifiers and other active electronic components can pick-up the PDH sideband frequency Q via electromagnetic interference (EMI) and introduce other unwanted phase-shifts in the signal prior to demodulation. These phase-shifts translate to error signal offsets after demodulation. For example, with reference to the laser frequency stabilization system 100 of FIG. 1. The power amplifier 117, which the EOM 106 relies on to produce the required phase modulation depth, is prone to radiating a signal at frequency Ω. This radiated signal can couple into the photodetector 114, its cabling, and/or a high gain amplifier (not illustrated in FIG. 1), thereby driving a signal into the photodetector 114 and creating a spurious bias signal indistinguishable from the photodetected signal at frequency Ω. When demodulated, this spurious signal can produce an uncontrolled, time varying bias of the error signal. Similarly, the power amplifier 119, which is required for driving the LO port of the mixer 120 with Sufficient power, generates an output that may couple into the RF input side of the mixer 120. The resulting bias is, after demodulation, indistinguishable from the true error signal. Any time-varying fluctuation in this coupling leads to decreased laser stability.

Fourth, other analog components in addition to the mixer exhibit temperature sensitivity, have offsets and error/tolerance stack-up, and may require parts to be replaced, entailing desoldering and/or soldering.

The aforementioned limitations of analog PDH feedback control circuits represent potential sources of both error and time variation/instability in PDH feedback control.

### Digital PDH Feedback Control

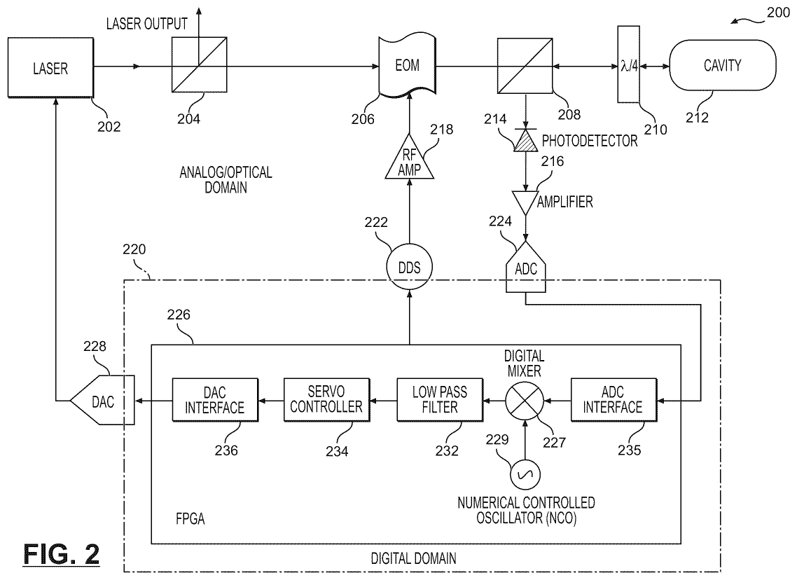

More recently, in order to combat the sources of error introduced by limitations in analog PDH feedback control circuits, laser frequency stabilization systems that utilize digital components have been developed. FIG. 2 illustrates a PDH laser frequency stabilization system 200 that utilizes digital circuitry to process a feedback signal and generate a control signal for stabilizing the frequency of a laser beam.

The PDH laser frequency stabilization system 200 is similar to the PDH laser frequency stabilization system 100 except it replaces many of the above described analog components with digital components. Because the demodulation of the detected optical signal is performed digitally via a programmable logic device, it becomes a purely mathematical operation completely immune to aging. At the same time, all potential sources of analog offsets are eliminated. Furthermore, the laser frequency stabilization system 200 facilitates frequency offset locking. When operated to provide frequency offset locking of the laser 202, the PDH modulation frequency itself is never physically realized, thereby eliminating the source of coherent EMI. The PDH laser frequency stabilization system 200 is capable of very precisely locking the frequency of a beam emitted by laser 202 to the peak of the resonance of the reference cavity 212 and, simultaneously, providing a tunable laser output via offset locking.

The PDH laser frequency stabilization system 200 includes a laser 202, a beam splitter 204, an EOM 206, a PBS 208, a quarter-wave plate 210, a reference cavity 212, a photodetector 214, an amplifier 216, an RF amplifier 218, and a digital domain circuit 220. The digital domain circuit 220 encompasses a direct digital synthesizer (DDS) 222, an Analog-to-Digital Converter (ADC) 224, a digital demodulation circuit 226, and a Digital-to-Analog Converter (DAC) 228. The digital demodulation circuit 226 includes an ADC interface 225, a digital mixer 227, a Numerically Controlled Oscillator (NCO) 229, a low pass filter 232, a servo controller 234, and a DAC interface 236.

In operation, the laser 202 of the PDH laser frequency stabilization system 200 emits a laser beam consisting primarily of electromagnetic radiation at an optical frequency of v. The laser beam emitted by laser 202 is incident on beam splitter 204, which splits the beam into an output beam and a feedback component beam. Specifically, the beam splitter 204 reflects a first portion of the laser radiation as the output beam and transmits a second portion of the laser radiation as the feedback component beam. The feedback component beam is incident on the EOM 206.

In a standard operating mode, the EOM 206 receives a drive signal at frequency Q from the DDS 222 that is amplified by the RF amplifier 218. The DDS 222 is phase locked to a system clock (not illustrated) of the digital demodulation circuit 226. The EOM 206 phase modulates the laser light signal at frequency Q to produce optical sidebands at v+/−Ω. The phase modulated laser light signal is incident on the reference cavity 212 (i.e., a Fabry-Perot cavity). When this light is reflected from the Fabry-Perot cavity 212, the light that coincides with a cavity resonance (carrier or sideband) will undergo a phase shift with respect to those portions that are non-resonant. In this manner, the reflected light is no longer purely phase modulated, but exhibits amplitude modulation at the frequency Ω.

In an offset locking mode, the EOM 206 receives a drive signal in the form of a carrier signal at a frequency Δ that is phase modulated at frequency Ω. This produces a phase modulated laser light signal with optical sidebands at (v±Δ) and (v±Δ)±Ω. The phase modulated laser light signal is incident on the Fabry-Perot cavity 212, which has an optical resonance at, e.g. v+Δ. When this light is reflected from the Fabry-Perot cavity 212, the light that coincides with a cavity resonance (carrier or sideband) will undergo a phase shift with respect to those portions that are non-resonant. In this manner, the reflected light is no longer purely phase modulated, but exhibits amplitude modulation at the frequency Ω. This offset locking technique allows the frequency v of the laser beam emitted by the laser 202 to be locked to a specific frequency (as demanded by a particular application, e.g. spectroscopy of a specific atomic species in a gas, atoms in an optical lattice, or an ion in an ion trap) that deviates from an optical resonance of the Fabry-Perot cavity 212 by an offset frequency Δ (which is tunable via adjustment of the frequency of the carrier signal used to drive the EOM 206).

In the laser frequency stabilization system 200 of FIG. 2, the reflected portion of the phase modulated laser light signal, which (in both the standard operating mode and the offset locking mode) exhibits amplitude modulation at the frequency Q (i.e. the amplitude modulated light), is sent to the photodetector 214 through the PBS 208 and the quarter-wave plate 210. Other equipment configurations prior to the photodetector 214 are also possible (e.g., a circulator, a beam splitter, etc.). The photodetector 214 detects the amplitude modulation of the amplitude modulated light and generates an electrical signal, i.e. a radiofrequency electrical signal, therefrom. The electrical signal is amplified by the amplifier 216 and provided to the ADC 224, which converts the electrical signal to a digital time series and provides the digital time series as input, via the ADC interface 225, to the digital domain 220.

The digital demodulation circuit 226 performs synchronous demodulation of the digital time series received from the ADC 224 via the ADC interface 225. In the PDH laser frequency stabilization system 200, the digital demodulation circuit 226 is a Field Programmable Gate Array (FPGA) 226. However, the digital demodulation circuit 226 can alternatively be implemented with an Application Specific Integrated Circuit (ASIC), a microprocessor, a Digital Signal Processor (DSP), or the like.

The FPGA 226 is configured to provide components for synchronously demodulating the digital time series from the ADC 224. For instance, the FPGA 226 includes the ADC interface 225 and implements a digital mixer 227. The NCO 229, implemented on the FPGA 226, serves as an LO for the digital mixer to demodulate the digital time series. This NCO 229 is also phase locked to the system clock (not illustrated) of the FPGA 226 (i.e., the system clock of the digital demodulation circuit 226, to which the DDS is also phase locked). The output of the digital mixer 227 provides a demodulated digital time series that is then filtered by a low pass filter 232, implemented on the FPGA 226, to provide a digital error signal. The low pass filter 232 can, e.g., be implemented as a digital Infinite Impulse Response (IIR) filter or as a Finite Impulse Response (FIR) filter.

The digital error signal is provided to a servo controller 234, which generates a control signal for a frequency control actuator of the laser 202. The servo controller 234 can be, e.g., one or multiple proportional-integral-derivative (PID) controllers. In the PDH laser frequency stabilization system 200, the servo controller 234 is implemented digitally within the FPGA 226. The output of the servo controller is provided to the DAC interface 236 and converted to a suitable correction signal by the DAC 228 and applied to the frequency control actuator of the laser 202. A suitable correction signal can be, e.g., a DC voltage to be applied to a PZT or a diode current driver, or an RF AC signal to be applied to an AOM. In this manner, the frequency of the laser beam emitted by laser 202 is stabilized.

PDH feedback control implementations that rely on digital circuitry, such as the PDH laser frequency stabilization system 200, also exhibit certain limitations. Specifically, digital systems exhibit signal time delays significantly longer than those of analog systems. The speed of a digital feedback circuit is limited both by the time required to process the feedback signal (e.g. by the time required for the FPGA 226 to perform proportional multiplication or summing for integration, etc.) and latency in the digital-to-analog and analog-to-digital conversion (e.g. by the time required for the ADC to convert the radiofrequency electrical signal provided by the photodetector 414 to a digital time series and the time required by the DAC to convert the digital error signal to an analog electrical signal). These delays in the signal propagation are typically on the order of 100-200 ns. Analog feedback paths, by contrast, can be made to have delays of less than 1 ns with suitable amplifiers.

In order to determine their impact on the locking loop bandwidth of a PDH feedback control implementation, it is useful to consider the analog and digital processing speeds in the context of the speed of the laser frequency actuators. Different actuators have different speeds and dynamic ranges. Actuator choice may be constrained by what is practical or available with a given laser system build, and also by the insertion loss of the usable optical power that accompanies the selection of a particular actuator. As an example, a modern extended cavity diode laser may have (i) an intra-cavity electro-optic modulator (EOM) with a nominal low pass filter corner frequency of 2 MHz, (ii) a feedback path to the bias current with a low pass filter corner frequency of 500 kHz, and (iii) a feedback path to a Piezo-electric transducer (PZT) which controls the grating angle with a few kHz or lower response frequency. When controlling such a laser, the PZT is clearly much slower than the digital circuit feedback speeds mentioned in the previous paragraph. However, the bias current and intracavity EOM actuators provide response speeds that are faster than the digital feedback circuit. Accordingly, depending on the choice of actuator that the digital feedback loop controls, the time delay of the digital feedback circuit can be the limiting factor that ultimately limits the maximum bandwidth achievable with a digital locking loop.

### Hybrid PDH Feedback Control

The present disclosure provides laser stabilization systems that include both a digital servo controller and an analog servo controller working in tandem to provide hybrid PDH feedback control for stabilizing the output frequency of a laser. Given a suitable actuator and/or set of actuators (which has/have a response speed faster than that of the digital locking loop itself), a hybrid system is capable of increasing the total locking loop bandwidth without sacrificing the precise frequency stabilization made possible by a digital system. The result is higher frequency unity gain bandwidths and frequency stabilized lasers with lower spectral densities of frequency noise. In addition, the hybrid PDH feedback control systems retain the enhanced usability afforded by digital systems, providing features such as automation of some tasks such as lock acquisition, system health monitoring, and performance data reporting, elimination of component variation/drift, remote control, and data collection. Furthermore, the hybrid PDH feedback control systems also provide for offset locking. Accordingly, the hybrid PDH feedback control systems offer a unique combination of high servo bandwidths and convenient implementation of offset locking operation.

The present disclosure provides hybrid PDH feedback control systems with a fast analog branch having an analog servo and a parallel digital branch having a digital servo. To ensure that the advantages of the digital servo are not negated, the parallel analog path implements a separate demodulation circuit involving a mixer. This analog demodulated signal is only used at high frequencies and therefore does not affect the long-term stability of the overall system, which is instead determined by the digital signal path. This analog demodulated signal thereby provides feedback without the delays associated with digitizing an RF signal output by the photodetector and also without the delays associated with the clock cycles required for digital demodulation. To provide for parallel analog and digital branches, a photodetector output signal is split, e.g. in an RF splitter, and each output is separately provided to the demodulation section/error signal generation section of the respective analog and digital servos.

The present disclosure provides hybrid PDH feedback control systems in which the analog and digital demodulators each generate their own error signal. The analog demodulation takes place in an analog mixer, which multiplies/mixes the RF photodetector signal with an electrical, i.e. RF, realization of the appropriate local oscillator signal. The digital demodulation takes place by digitizing the RF photodetector signal and multiplying the resulting numerical representation of the RF photodetector signal with a numerical LO, using a numerical mixer. The electrical version of the local oscillator for the mixer in the analog branch can be generated numerically within the digital system, with the means to correctly set the phase of this local oscillator, and can then be converted to an electrical signal in an DAC or a DDS. These error signals proceed in parallel to their respective loop filter/servo sections, in which the gain as a function of frequency is shaped to optimize the feedback process.

The digital error signal, now a numerical time series, is optimized for operation within the constraints of the speed of the digital system and the actuator/s it uses for frequency control. Note that there may be a few actuators of different response speeds and dynamic ranges, and these may be driven in parallel with appropriate crossover networks, as discussed in the example above. After proportional, integral, and possibly differential (PID) gain in the numerical signal processing, this signal may be converted to a voltage for control of an actuator. This voltage may be baseband (say from DC or a low frequency to a few MHz), or it may be impressed on a carrier in the case of an acousto-optic modulator.

The analog error signal exits the analog mixer and its gain versus offset frequency profile is optimized in what we refer to as the loop filter section. This usually requires the use of an amplifier in addition to other components. The phase response of gain-shaping components and their combination is generally unavoidable as they are limited by the Kramers-Kronig relationship. High speed amplifiers help minimize any additional phase delays in this part of the circuit. When not limited by the actuator, the use of amplifiers such as these allows for considerably faster feedback signals than a digital circuit. In general, the highest speed analog feedback signals in the loop filter section of a feedback circuit are either proportional or differential (not integral). High speed amplifiers are very useful for creating differential gain circuits to MHz frequencies. After the last amplifier of the analog loop filter, the voltage signal will directly drive an actuator, or be summed with the voltage from a digital feedback path to drive an actuator. It is important to note that the error signal at frequencies above the cavity linewidth is proportional to phase rather than frequency and, therefore, if a frequency actuator is used a lead-lag circuit may be necessary to take full advantage of the fast analog path. Optimum lead-lag circuit design takes into account the cavity linewidth and the maximum attainable actuator speed.

The present disclosure thereby provides hybrid PDH feedback control systems in which two parallel signal paths are created. The digital path makes for precision locking and allows for offset locking, while the analog path makes for high speed signals and, in particular, the use of high speed differential gain. This hybrid approach makes for servo control of laser frequency that is better optimized for practical use and laser frequency noise suppression.

The bandwidth of the locking loop is of crucial importance for the suppression of laser frequency noise at relatively high offset frequencies. Within the context of feedback control theory, and considering the frequency domain picture and the spectral density of frequency noise, the free-running laser frequency noise is suppressed by the magnitude of the gain of the feedback path. A feedback path with faster response (the feedback speed may be defined as the offset frequency at which the phase of the round-trip signal is delayed by, e.g., 120 degrees) allows gain and hence noise suppression out to higher frequencies.

Some applications require suppression of frequency noise in certain frequency bands. For example, the spectroscopy of an ion in an ion trap requires that frequency noise of the interrogating laser at the frequency of the secular motion of the ion be minimized. Since this secular motion frequency may well be in the MHz frequency range, a feedback path is required that provides gain and noise suppression in the MHz offset frequency band.

According to a first aspect, the present disclosure provides a laser stabilization system for stabilizing a laser beam emitted by a laser at a target frequency. According to an embodiment of the first aspect, the laser stabilization system includes a phase modulator configured to receive laser radiation provided by the laser, to apply a phase modulation to the received laser radiation, and to provide, as output, phase modulated laser radiation. The laser stabilization system also includes an optical cavity configured to receive the phase modulated laser radiation and to provide amplitude modulated measurement radiation, and an optical detector configured to receive the amplitude modulated measurement radiation from the optical cavity and to generate, based on the received amplitude modulated measurement radiation, a radiofrequency electrical signal. The laser stabilization system additionally includes a signal distribution network configured to receive the radiofrequency electrical signal and to provide, based on the radiofrequency electrical signal, a digital branch electrical input signal and an analog branch electrical input signal. The laser stabilization system further includes a digital control circuit configured to receive the digital branch electrical input signal and to generate, based on the digital branch electrical input signal, a first control signal, and an analog control circuit configured to receive the analog branch electrical input signal and to generate, based on the analog branch electrical input signal, a second control signal. In addition, the laser stabilization system includes an output interface configured to supply laser control output to the laser based on the first control signal and the second control signal.

In variants of the laser stabilization system according to the aforementioned embodiment of the first aspect, the signal distribution network comprises a splitter configured to split the radiofrequency electrical signal into the digital branch electrical input signal and the analog branch electrical input signal.

The laser stabilization system according to the aforementioned embodiment can further include the laser itself and a beam splitter configured to extract, from the laser beam emitted by the laser, a laser beam component consisting of the laser radiation that the phase modulator is configured to receive.

In variants of the laser stabilization system according to the aforementioned embodiment of the first aspect, the laser control output includes a first laser control component and a second laser control component. The output interface comprises a first actuator interface configured to supply the first control signal to a first actuator of the laser as the first laser control component, and a second actuator interface configured to supply the second control signal to a second actuator of the laser as the second laser control component. The first actuator can be, e.g., a piezo-electric transducer (PZT), and the second actuator can be, e.g., an intra-cavity electro-optic modulator (EOM), an external EOM, an external acousto-optic modulator, or (in the case of a diode-based laser) a diode current source.

In variants of the laser stabilization system according to the aforementioned embodiment of the first aspect, the laser control output is a combined laser control signal that is a sum of the first control signal and the second control signal, and the output interface comprises an actuator interface configured to supply the combined laser control signal to one or more actuators of the laser. The one or more actuators can include one or more of a piezo-electric transducer (PZT), an intra-cavity electro-optic modulator (EOM), an external EOM, an external acousto-optic modulator, or a diode current source. In addition, in certain implementations, the laser output can be controlled via a semiconductor optical amplifier used in saturation mode or via the injection of amplitude modulated light into a diode laser to change its index of refraction at faster-than-thermal rates.

In variants of the laser stabilization system according to the aforementioned embodiment of the first aspect, the digital signal control circuit includes an analog-to-digital converter (ADC) configured to convert the radiofrequency electrical signal into a digital time series and a digital mixer configured to mix the time series of the radiofrequency electrical signal with a digital representation of the phase modulation applied by the phase modulator to the laser radiation to provide a demodulated digital error signal. The digital representation of the phase modulation has a selectable phase shift relative to the phase modulation applied by the phase modulator. The digital signal control circuit further includes a digital servo configured to convert the demodulated digital error signal into a digital output signal and a digital-to-analog converter (DAC) configured to generate the first control signal from the digital output signal.

In variants of the laser stabilization system according to the aforementioned embodiment of the first aspect, the analog signal control circuit includes an analog mixer configured to mix, in order to provide a mixed analog error signal, the second radiofrequency electrical signal with an electrical manifestation of a digital signal that represents the phase modulation applied by the phase modulator to the laser radiation. The electrical manifestation of the digital signal that represents the phase modulation has a phase shift relative to the phase modulation applied by the phase modulator. The analog signal control circuit further includes an analog servo configured to generate the second control signal from the mixed analog error signal.

In variants of the laser stabilization system according to the aforementioned embodiment of the first aspect, the phase modulator is configured to be driven by a phase modulated carrier signal. The carrier signal has a frequency equal to an offset frequency, and the digital signal control circuit is configured to generate the first control signal to control the laser to produce laser light at a frequency equal to a resonant frequency of the optical cavity plus or minus the offset frequency. In variants of the laser stabilization system according to the aforementioned embodiment of the first aspect, a digital branch is configured to perform demodulation using a first PDH frequency and an analog branch is configured to perform demodulation using a second PDH frequency that is different from the first PDH frequency.

According to a second aspect, the present disclosure provides a method for generating a control signal for tuning a laser beam emitted by a laser to a target frequency. According to an embodiment of the second aspect, the method includes applying, by a phase modulator, a phase modulation to laser radiation output by the laser to produce phase modulated laser radiation, directing the phase modulated laser radiation to an optical cavity, providing, by the optical cavity from the phase modulated laser radiation, amplitude modulated measurement radiation, and directing the amplitude modulated measurement radiation to an optical detector. The method also includes generating, by the optical detector from the amplitude modulated measurement radiation, a radiofrequency electrical signal, supplying, by a signal distribution network and based on the radiofrequency electrical signal, a digital branch electrical input signal and an analog branch electrical input signal. The method additionally includes generating, by a digital control circuit based on the digital branch electrical input signal, a first control signal, generating, by an analog control circuit based on the analog branch electrical input signal, a second control signal, and supplying, to the laser, laser control output for stabilizing the laser at the target frequency. The laser control output is based on the first control signal and the second control signal.

In variants of the method for generating a control signal for tuning a laser beam according to the aforementioned embodiment of the second aspect, the supplying, by the signal distribution network, the digital branch electrical input signal and the analog branch electrical input signal comprises splitting, by a splitter, the radiofrequency electrical signal into the digital branch electrical input signal and the analog branch electrical input signal.

The method for generating a control signal for tuning a laser beam according to the aforementioned embodiment of the second aspect can further include extracting, by a beam splitter from the laser beam emitted by the laser, a laser beam component consisting of the laser radiation to which the phase modulator applies the phase modulation.

In variants of the method for generating a control signal for tuning a laser beam according to the aforementioned embodiment of the second aspect, the supplying the laser control output to the laser includes supplying a first component signal of the laser control output to a first actuator of the laser and supplying a second component signal of the laser control output to a second actuator of the laser. The first actuator can, e.g., be a piezo-electric transducer (PZT), and the second actuator can, e.g., be an intra-cavity electro-optic modulator (EOM), an external EOM, an external acousto-optic modulator, or a diode current source.

In variants of the method for generating a control signal for tuning a laser beam according to the aforementioned embodiment of the second aspect, the laser control output is a combined laser control signal that is a sum of the first control signal and the second control signal, and the supplying the laser control output to the laser comprises supplying the combined laser control signal to one or more actuators of the laser. The one or more actuators can include one or more of a piezo-electric transducer (PZT), an intra-cavity electro-optic modulator (EOM), an external EOM, an external acousto-optic modulator, or a diode current source.

In variants of the method for generating a control signal for tuning a laser beam according to the aforementioned embodiment of the second aspect, the generating, by the digital control circuit based on the digital branch electrical input signal, the first control signal includes converting, by an analog-to-digital converter (ADC), the digital branch electrical input signal into a digital time series and mixing, by a digital mixer, the digital time series with a digital representation of the phase modulation to provide a demodulated digital error signal. The digital representation of the phase modulation has a selectable phase shift relative to the phase modulation applied by the phase modulator. Generating the first control signal further includes converting, by a digital servo, the demodulated digital error signal into a digital output signal and generating, by a digital-to-analog converter (DAC), the first control signal from the digital output signal.

In variants of the method for generating a control signal for tuning a laser beam according to the aforementioned embodiment of the second aspect, the generating, by the analog control circuit based on the analog branch electrical input signal, the second control signal includes mixing, by an analog mixer, the analog branch electrical input signal with an electrical manifestation of a digital representation of the phase modulation to provide a mixed analog error signal. The electrical manifestation of the digital representation of the phase modulation has a phase shift relative to the phase modulation applied by the phase modulator. The generating the second control circuit further includes generating, by an analog servo, the second control signal from the mixed analog error signal.

In variants of the method for generating a control signal for tuning a laser beam frequency according to the aforementioned embodiment of the second aspect, the generating the phase modulation is produced by driving the phase modulator with a phase modulated carrier signal, the carrier signal having a frequency equal to an offset frequency. The target frequency is equal to a resonant frequency of the optical cavity plus or minus the offset frequency. In variants of the method for generating a control signal for tuning a laser beam frequency according to the aforementioned embodiment of the second aspect, a digital branch is configured to perform demodulation using a first PDH frequency and an analog branch is configured to perform demodulation using a second PDH frequency that is different from the first PDH frequency.

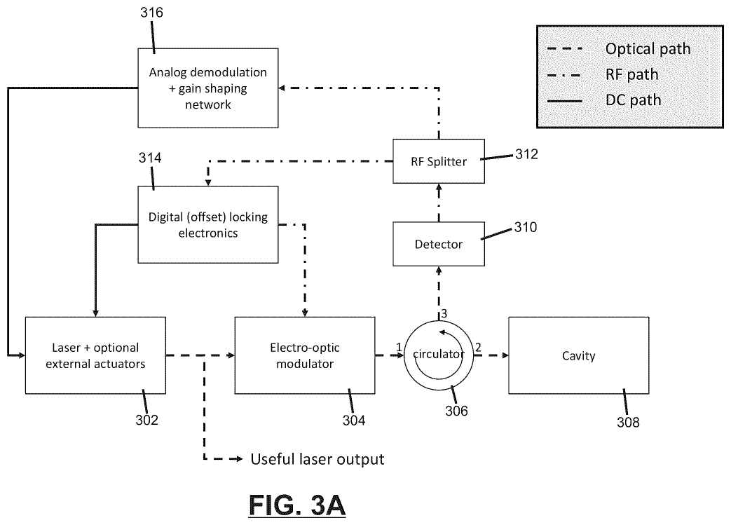

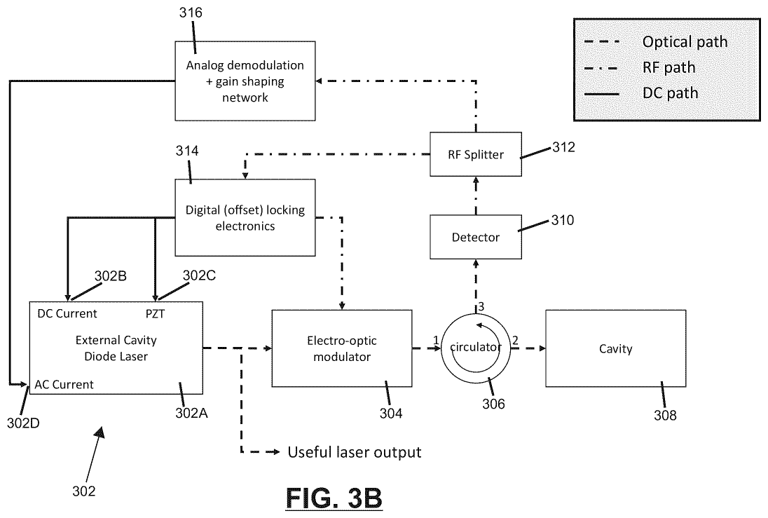

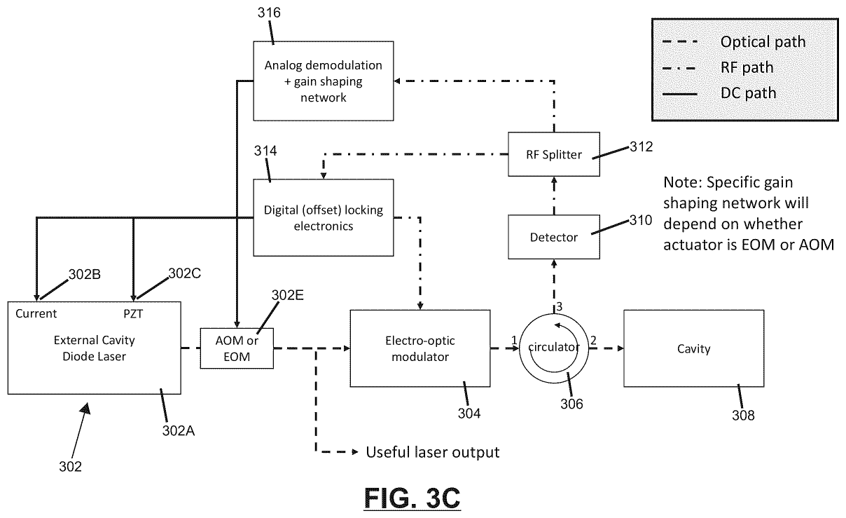

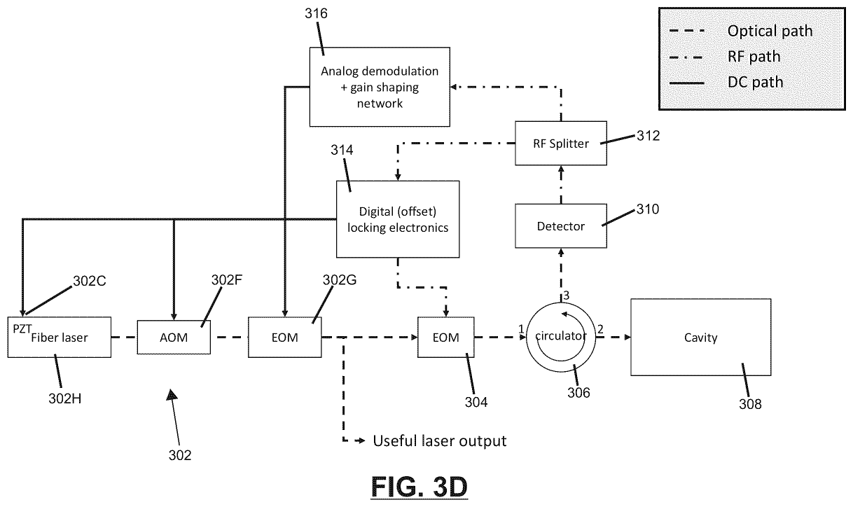

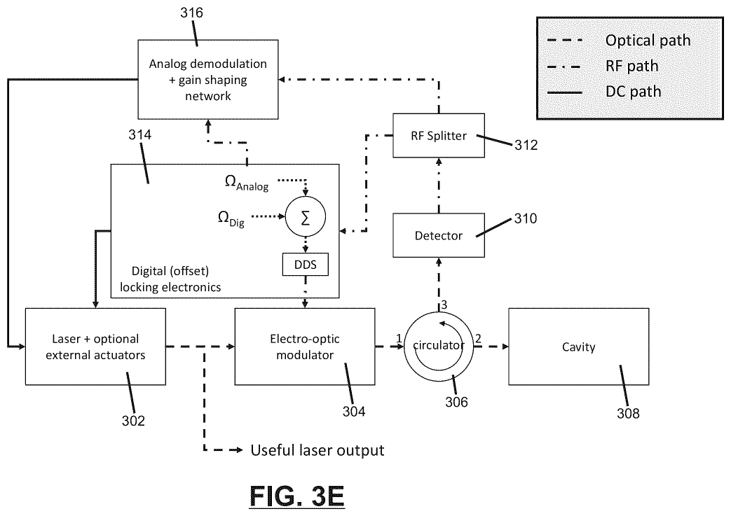

FIG. 3A illustrates a general architecture for a hybrid PDH laser frequency stabilization system, which includes a digital control branch and an analog control branch, that utilizes hybrid circuitry to process a feedback signal and generate control signals for stabilizing the output frequency of a laser beam. The general architecture illustrated in FIG. 3A includes a laser system 302, which includes a laser combined with one or more, potentially external, laser actuators, an optical phase modulator 304, a circulator 306, an optical reference cavity 308, an optical detection system 310, a splitter 312, and parallel digital and analog control branches. The digital control branch includes digital locking electronics 314, and the analog control branch includes analog demodulation and gain shaping network 316.

The laser system 302 includes a laser, which can be, e.g., a gas laser, a chemical laser, a solid-state laser, a semiconductor laser, or a fiber laser, and a number of laser actuators that control an operating parameter of the laser. Depending on the specific type of laser, the actuators can include, e.g., a piezo-electric transducer (PZT), which can, e.g., adjust the laser cavity length, e.g. by stretching a fiber or moving a mirror or grating. The actuators can also include, e.g., an intra-cavity electro-optic modulator (EOM), an external EOM, an external acousto-optic modulator, or a diode current source. The laser is configured to emit a laser beam having an optical frequency of v. Various combinations of actuators and the control thereof by the respective digital and analog control branches are illustrated in FIGS. 3B through 3D.

In operation, the laser system 302 emits a laser beam consisting primarily of electromagnetic radiation at an optical frequency of v. The laser beam emitted by laser system 302 is split (e.g. by a beam splitter, not illustrated) into an output beam (i.e. useful laser output) and a feedback component beam. The feedback component beam is incident on the optical phase modulator 304.

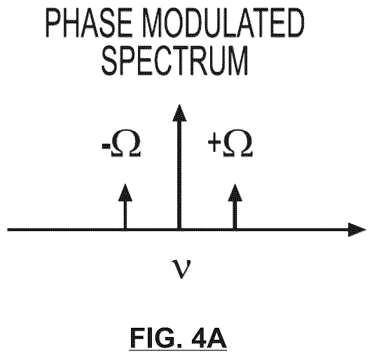

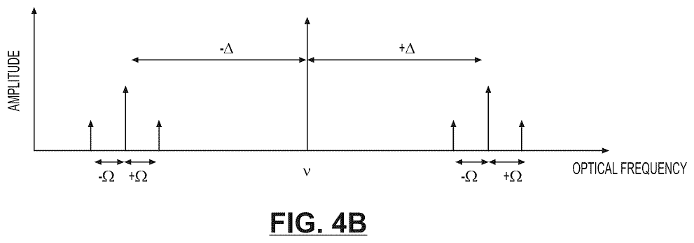

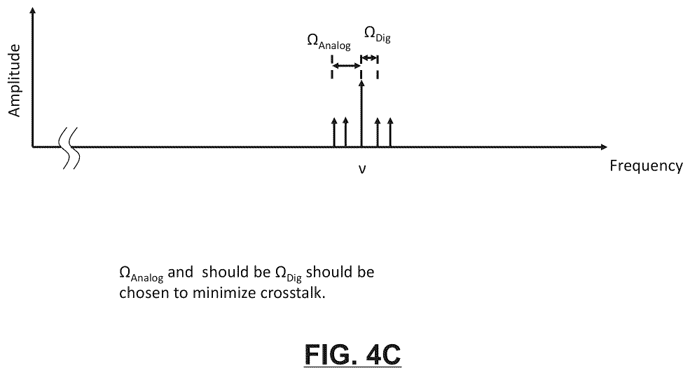

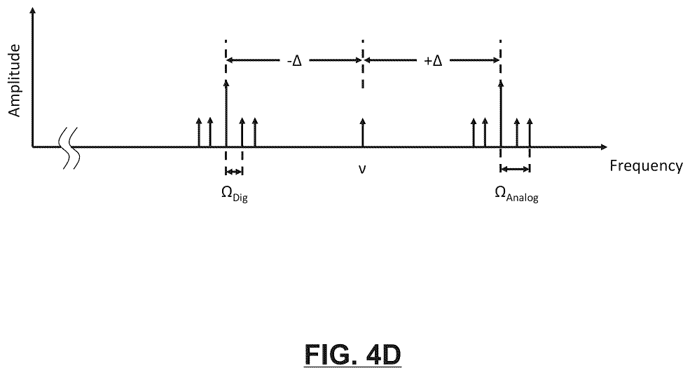

The optical phase modulator 304 is configured to phase modulate the laser radiation transmitted thereto from the laser system 302. The optical phase modulator 304 can be, e.g., a single EOM or, in some embodiment, a combination of multiple EOMs. In a standard PDH operating mode, the phase modulator 304 is driven at frequency Q and phase modulates the laser light signal at frequency Q to produce optical sidebands at v±Ω. For example, the optical phase modulator 304 can be driven by a drive signal produced by a DDS of the digital locking electronics 314 and amplified by an RF amplifier. The optical phase modulator 304 then phase modulates the laser light signal at the frequency Q to produce optical sidebands at v+/−Ω. The phase modulated laser light signal is incident on the optical reference cavity 308 (i.e., a Fabry-Perot cavity). When this light is reflected from the Fabry-Perot cavity 308, the light that coincides with a cavity resonance (carrier or sideband) will undergo a phase shift with respect to those portions that are non-resonant. In this manner, the reflected light is no longer purely phase modulated, but exhibits amplitude modulation at the frequency Ω. The phase modulated laser light signal produced in the standard PDH operating mode is represented by an amplitude vs. frequency plot in FIG. 4A.

Alternatively, in an offset locking mode, the phase modulator is driven to produce a carrier signal, which has a frequency Δ, that is phase modulated at frequency Q to produce optical sidebands at (v±Δ) and (v±Δ)±Ω. For example, the optical phase modulator 304 can be driven by a drive signal produced by a DDS of the digital locking electronics 314 and amplified by an RF amplifier. In the offset locking mode, the optical phase modulator 304 receives a drive signal in the form of a carrier signal at a frequency Δ that is phase modulated at frequency Ω. The optical phase modulator 304 then phase modulates the laser light signal to produce a phase modulated laser light signal with optical sidebands at (v±Δ) and (v±Δ) Ω. The phase modulated laser light signal is incident on the Fabry-Perot cavity 308, which has an optical resonance at, e.g. v+Δ. When this light is reflected from the Fabry-Perot cavity 308, the light that coincides with a cavity resonance (carrier or sideband) will undergo a phase shift with respect to those portions that are non-resonant. In this manner, the reflected light is no longer purely phase modulated, but exhibits amplitude modulation at the frequency Ω. This offset locking technique allows the frequency v of the laser beam emitted by the laser system 302 to be locked to a specific frequency (as demanded by a particular application, e.g. spectroscopy of an ion in an ion trap) that deviates from an optical resonance of the Fabry-Perot cavity 308 by an offset frequency Δ (which is tunable via adjustment of the frequency of the carrier signal used to drive the optical phase modulator 304). The phase modulated laser light signal produced in the offset locking mode is represented by an amplitude vs. frequency plot in FIG. 4B.

The general architecture illustrated in FIG. 3A for a hybrid PDH laser frequency stabilization system enables the use of multiple PDH frequencies. The use of separate and orthogonal PDH frequencies by the respective servos in the digital control branch and in the analog control branch ensures that generating a local oscillator for analog demodulation does not interfere with the digital system. Specifically, the architecture illustrated in FIG. 3A enable the optical phase modulator to be driven, in a standard PDH operating mode with multiple PDH frequencies, by a combined, or summed, signal that has multiple frequency components. In this manner, the digital locking electronics 314 and the analog demodulation and gain shaping network 316 utilize separate and orthogonal PDH frequencies. In a standard PDH operating mode with multiple PDH frequencies, the optical phase modulator can be driven at frequencies Ω_{digital} and Ω_{analog} to produce optical sidebands at both v Ω_{digital} and v±Ω_{analog}. The phase modulated laser light signal produced in the standard PDH operating mode with dual PDH frequencies is represented by an amplitude vs. frequency plot in FIG. 4C.

Alternatively, in an offset locking mode with multiple PDH frequencies, the phase modulator is driven to produce a carrier signal, which has a frequency Δ, that is phase modulated at frequencies Ω_{digital} and Ω_{analog} to produce optical sidebands at both (v±Δ) Ω_{digital} and (v±Δ)±Ω_{analog}—as well as at v±Δ. In both the standard PDH operating mode with multiple PDH frequencies and the offset locking mode with multiple PDH frequencies, the optical phase modulator 304 phase modulates the laser light signal, the phase modulated laser light signal is incident on the optical reference cavity 308, and when light is reflected from the Fabry-Perot cavity 308, the light that coincides with a cavity resonance (carrier or sideband) will undergo a phase shift with respect to those portions that are non-resonant. In this manner, the reflected light is no longer purely phase modulated, but exhibits amplitude modulation at the frequencies Ω_{digital} and Ω_{analog} in both the standard PDH and offset locking operating modes. The phase modulated laser light signal produced in the offset locking mode with dual PDH frequencies is represented by an amplitude vs. frequency plot in FIG. 4D.

In the architecture illustrated in FIG. 3A, the optical phase modulator 304 can be driven, in dual PDH frequency operation modes, by a single signal generated by the digital locking electronics 314. The single signal can be a combination of two digital signals generated within the digital locking electronics 314—as is the case in the architecture illustrated in FIG. 3E. In this case, a digital summer, which is a component of the digital locking electronics, can combine, or sum, two separate digital signals-one being a digital representation of the frequency Ω_{digital} and another being a digital representation of the frequency Ω_{analog}. The combined signal can then be provided by the summer to a DDS, which outputs an analog signal than can be amplified and provided to the optical phase modulator 304. Alternatively, the digital locking electronics can generate two separate analog signals, e.g. by a first DDS and a second DDS. These separate analog signals can be summed and then amplified, or separately amplified and then summed, before being provided to drive the optical phase modulator 304. The separate analog signals can be summed by a suitable signal summer, e.g. a Wilkinson power combiner, a directional coupler, or a frequency multiplexer.

The circulator 306 is configured to receive phase modulated laser radiation from the optical phase modulator 304, to transmit the phase modulated laser radiation to the optical reference cavity 308, to receive amplitude modulated laser radiation that is reflected by the optical reference cavity 308, and to transmit the amplitude modulated laser radiation to the optical detection system 310. The optical reference cavity 308 is a Fabry-Perot cavity, and the laser radiation that is reflected by the optical reference cavity 308 (i.e. the amplitude modulated laser radiation) provides information that indicates the relationship of the optical frequency v of the laser radiation emitted by the laser system 302 relative to a resonant frequency of the optical reference cavity 308. Specifically, the modulation depth of the amplitude modulated laser radiation is related to a frequency difference of the optical frequency v to a resonance (e.g. the resonance center) of the optical reference cavity 308, and the sign of the amplitude modulation with respect to the demodulation signal indicates whether the cavity optical frequency v (or e.g. (v+Δ) in the case of offset locking) is above or below the resonance of the optical reference cavity 308.

The optical detection system 310 is configured to receive the amplitude modulated laser radiation from the circulator 306 and to generate, from the amplitude modulated laser radiation, a radiofrequency electrical signal. The optical detection system 310 can be, e.g., a photodetector. In addition, the optical detection system 310 can also include a transimpedance amplifier, which amplifies the output of a photodetector. In addition to amplifying the output of the photodetector, a transimpedance amplifier can also turn a current (e.g. a photocurrent) signal into a voltage signal and decouple the impedance of the circuit in front of the photodetector from the following circuitry. The radiofrequency electrical signal includes the same information as the amplitude modulated laser radiation regarding the relationship of the optical frequency v of the laser radiation emitted by the laser system 302 relative to a resonant frequency of the optical reference cavity 308. The splitter 312, which, in FIG. 3A, is an RF splitter, splits the radiofrequency electrical signal generated by the optical detection system 310 into (i) a digital branch radiofrequency electrical input signal and (ii) an analog branch radiofrequency electrical input signal.

The digital locking electronics 314 is configured to receive the digital branch radiofrequency electrical input signal and generate, based on the digital branch input signal, a first control signal for controlling one or more actuators of the laser system 302. The digital locking electronics 314 can include, e.g., a digital signal generator, an Analog-to-Digital Converter (ADC), a digital demodulation circuit, and a Digital-to-Analog Converter (DAC). The digital signal generator can be, e.g., a direct digital synthesizer (DDS), and the digital demodulation circuit can be implemented as a Field Programmable Gate Array (FPGA), an Application Specific Integrated Circuit (ASIC), a microprocessor, or a Digital Signal Processor (DSP). The digital demodulation circuit can include an ADC interface, a digital mixer, a Numerically Controlled Oscillator (NCO), a low pass filter, a digital servo controller, and a DAC interface.

The digital locking electronics 314 receive the digital branch radiofrequency electrical input signal, convert the radiofrequency electrical input signal to a digital time series, and perform synchronous demodulation of the digital time series received from the ADC. For this purpose, the digital locking electronics 314 can utilize a digital mixer and an NCO that serves as an LO for the digital mixer to demodulate the digital time series. The NCO can also serve as a source of a signal that serves as a LO for an analog mixer of the analog demodulation and gain shaping network 316, as detailed below. Alternatively, a separate NCO can serve as a source of a signal that serves as a LO for an analog mixer of the analog demodulation and gain shaping network 316, as also detailed below. Both the NCO and the separate NCO, if one is provided, are phase locked to a system clock of the digital locking electronics 314.

The digital locking electronics 314 can include a low pass filter configured to filter the output of the digital mixer (i.e. a demodulated digital time series) to provide a digital error signal. The low pass filter an, e.g., be implemented as a digital Infinite Impulse Response (IIR) filter or as a Finite Impulse Response (FIR) filter. The digital error signal is provided to a servo controller of the digital locking electronics 314, which generates a control signal for a frequency control actuator of the laser. The servo controller can be, e.g., one or multiple proportional-integral-derivative (PID) controllers implemented digitally within a Field Programmable Gate Array (FPGA), an Application Specific Integrated Circuit (ASIC), a microprocessor, a Digital Signal Processor (DSP), or the like. The output of the servo controller is provided to a DAC interface and converted to a suitable correction signal (e.g. a DC voltage or a radiofrequency correction signal) by a DAC and applied to one or more frequency control actuators of the laser system 302. In this manner, the frequency of the laser beam emitted by laser system 302 is stabilized.

The analog demodulation and gain shaping network 316 is configured to receive the analog branch radiofrequency electrical input signal and generate, based on the analog branch input signal, a second control signal for controlling one or more actuators of the laser system 302. The analog demodulation and gain shaping network 316 can include, e.g., a Local Oscillator (LO), a phase shifter, a mixer, a low pass filter, and an analog servo controller.

The analog demodulation and gain shaping network 316 synchronously demodulates the analog branch radiofrequency input signal (which can be amplified prior to being demodulated) to provide a demodulated electrical signal. In order to demodulate the amplified analog branch radiofrequency input signal, the analog mixer utilizes an LO, which can be, e.g., a DDS provided in the digital locking electronics 314 that is configured to generate a radiofrequency output signal. Alternatively, the LO can be, e.g., a LO separate from the digital locking electronics 314.

The analog demodulation and gain shaping network 316 may further include circuitry for tuning a phase of the signal provided by the LO to provide a desired phase relationship with the analog branch radiofrequency electrical input signal. Alternatively, such phase tuning circuitry may be provided as a component of the digital locking electronics (i.e. when the LO utilized by the analog mixer is provided in the digital locking electronics 314). Suitable phase tuning circuitry is necessary to optimize the error signal slope/gradient to give the maximum sensitivity to the laser's frequency noise by accounting for a phase difference between the LO of the analog demodulation and gain shaping network 316 and the analog branch radiofrequency electrical input signal. The static configuration of the signal paths may not initially provide the required demodulation phase difference.

After demodulation at the analog mixer, the demodulated electrical signal can be filtered at a low pass filter, a high pass filter, and/or a lead-lag compensator of the analog demodulation and gain shaping network 316 to attenuate components in the demodulated signal and thereby obtain an error signal usable for tuning the optical frequency v of the laser system 302. Thereafter, the error signal can be conditioned by an amplifier and provided to a servo controller which is connected to a frequency control actuator of the laser system 302. The servo controller can be, e.g., a Proportional-Integral-Derivative (PID) servo controller or a servo controller that includes only proportional and derivative terms (which would not interfere with a DC control of the digital branch). The output of the servo controller is provided to a frequency control actuator of the laser system 302 to tune the optical frequency v of the laser beam emitted by the laser system 302 based on the error signal.

FIGS. 3B through 3D illustrate general architectures, similar to that of FIG. 3A described above, for a PDH laser frequency stabilization system that utilizes hybrid circuitry, and different actuator control configurations. Many components of the general architectures of FIGS. 3B through 3D are identical to those of FIG. 3A, and the same reference numerals used in FIG. 3A are used in FIGS. 3B through 3D to identify the identical components.

FIG. 3B illustrates a general architecture for a hybrid PDH laser frequency stabilization system in which the laser system 302 includes an external cavity diode laser 302A and three separate actuators: DC current input 302B, piezoelectric transducer (PZT) 302C, and AC current input 302D. In the architecture of FIG. 3B, the digital locking electronics 314 are configured to output two separate control signals. Specifically, the digital locking electronics 314 includes a first actuator interface 314A configured to supply a first control signal to the DC current input 302B of the external cavity diode laser 302A and a second actuator interface 314B configured to supply a second control signal to the PZT 302C of the external cavity diode laser 302A. The analog demodulation and gain shaping network 316 includes a single actuator interface 316A configured to output a third control signal to the AC current input 302D of the external cavity diode laser 302A.

FIG. 3C illustrates a general architecture for a hybrid PDH laser frequency stabilization system in which the laser system 302 includes an external cavity diode laser 302A and three separate actuators: current input 302B of the external cavity diode laser 302A, piezoelectric transducer (PZT) 302C of the external cavity diode laser 302A, and a separate optical modulator 302E in the form of either an acousto-optical modulator (AOM) or an electro-optical modulator (EOM). In the architecture of FIG. 3C, the digital locking electronics 314 are configured to output two separate control signals. Specifically, the digital locking electronics 314 includes a first actuator interface 314A configured to supply a first control signal to the current input 302B of the external cavity diode laser 302A and a second actuator interface 314B configured to supply a second control signal to the PZT 302C of the external cavity diode laser 302A. The analog demodulation and gain shaping network 316 includes a single actuator interface 316A configured to output a third control signal to the AOM/EOM 302E.

FIG. 3D illustrates a general architecture for a hybrid PDH laser frequency stabilization system in which the laser system 302 includes a fiber laser 302H and three separate actuators: piezoelectric transducer (PZT) 302C, an acousto-optic modulator (AOM) 302F, and an electro-optic modulator 302G. In the architecture of FIG. 3B, the digital locking electronics 314 are configured to output two separate control signals. Specifically, the digital locking electronics 314 includes a first actuator interface 314A configured to supply a first control signal to the PZT 302C of the fiber laser 302H and a second actuator interface 314B configured to supply a second control signal to the AOM 302F. The analog demodulation and gain shaping network 316 includes a single actuator interface 316A configured to output a third control signal to the EOM 302G.

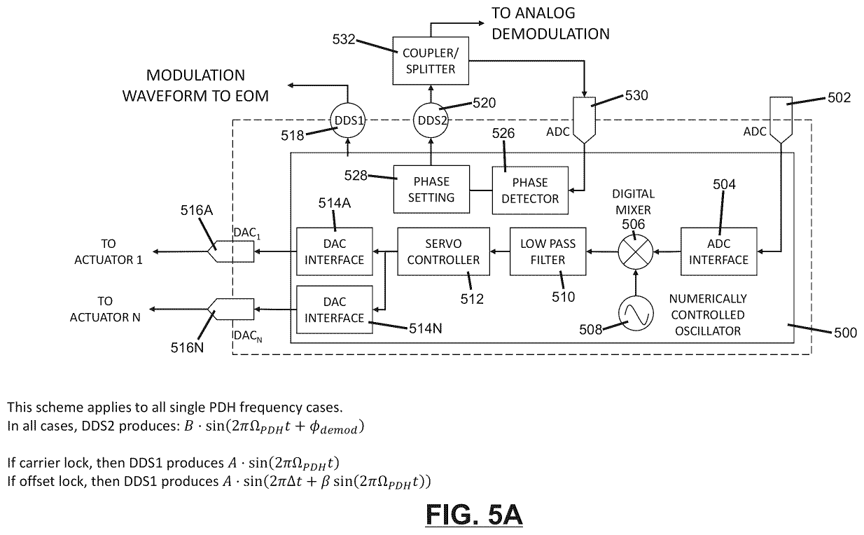

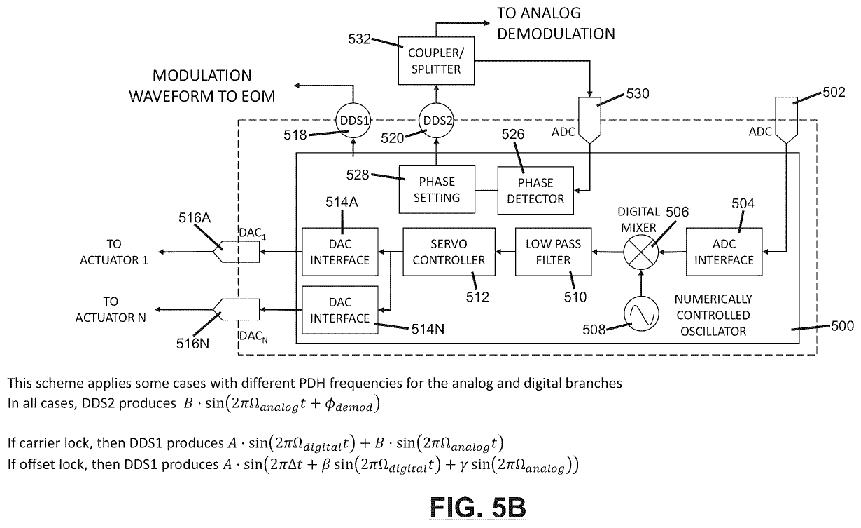

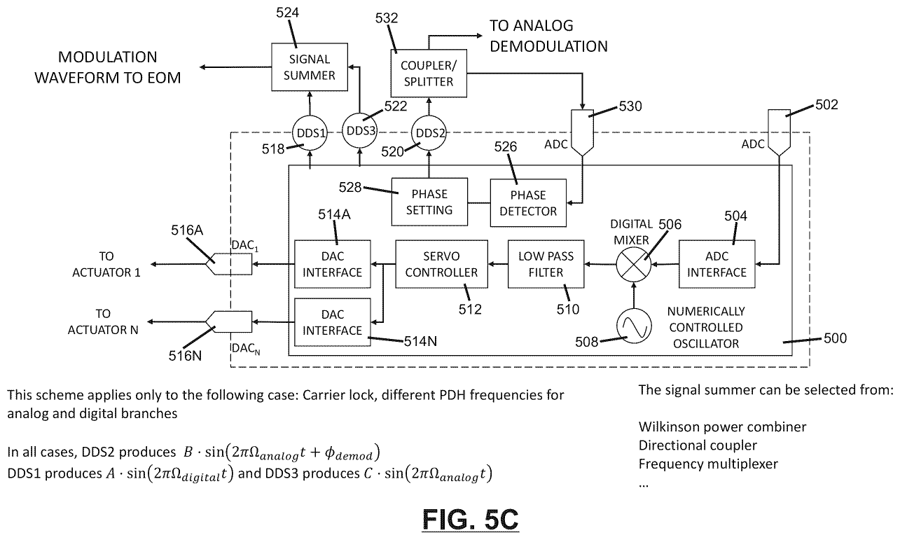

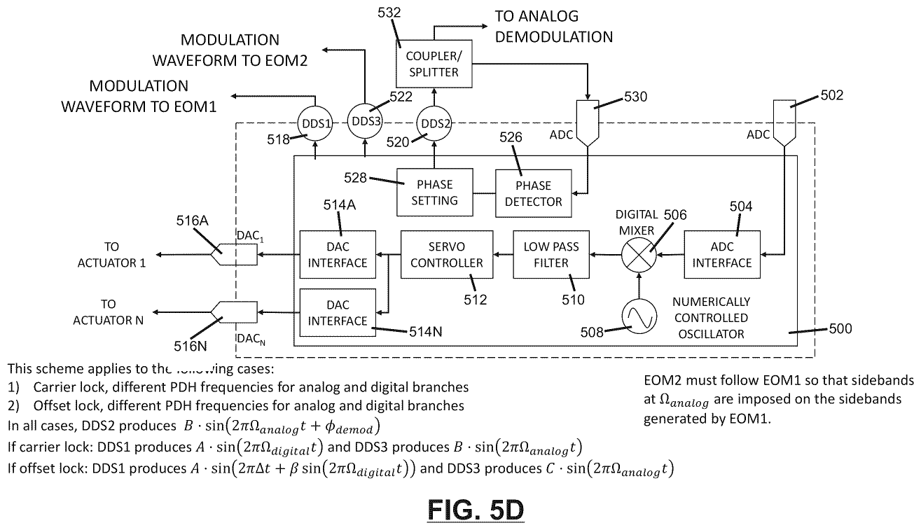

FIGS. 5A through 5D illustrate digital circuitry suitable for use as digital locking electronics of a hybrid PDH laser frequency stabilization system constructed according to one of the general architectures provided in FIGS. 3A through 3E. Many components of the digital circuitry provided in FIGS. 5A through 5D are identical, and the same reference numerals are used across FIGS. 5A through 5D to identify identical components. In each of FIGS. 5A through 5D, a digital demodulation circuitry 500, which includes suitable individual digital circuit components (e.g. ADC interface 504, digital mixer 506, NCO 508, low pass filter 510, servo controller 512, and DAC interfaces 514A through 514N) can be implemented as a Field Programmable Gate Array (FPGA), an Application Specific Integrated Circuit (ASIC), a microprocessor, or a Digital Signal Processor (DSP), for example.

FIG. 5A illustrates components of digital locking electronics 314 according to an embodiment of a hybrid PDH laser frequency stabilization system configured for single frequency PDH operation. The digital locking electronics 314 includes an ADC 502, which receives the digital branch radiofrequency electrical input signal (e.g. from the splitter 312 or from an amplifier that amplifies a radiofrequency electrical input signal provided by the splitter) and converts the digital branch radiofrequency electrical input signal to a digital time series. The ADC 502 provides the digital time series as input to the digital demodulation circuitry 500, via ADC interface 504. The digital mixer 506 receives the digital time series and, in addition to the digital time series, an output of a numerically controlled oscillator (NCO) 508. The NCO 508 is phase locked to a system clock of the digital demodulation circuitry 500. The output of the digital mixer 506 provides a demodulated digital time series that is then filtered by a low pass filter 510 to provide a digital error signal. The low pass filter 510 can, e.g., be implemented as a digital Infinite Impulse Response (IIR) filter or as a Finite Impulse Response (FIR) filter. The output of the low pass filter 510 is then provided to servo controller 512 as an error signal.

The servo controller 512 generates control output in the form of one or more control signals for controlling one or more frequency control actuators of the laser system 302. The servo controller 512 can be, e.g., one or multiple proportional-integral-derivative (PID) controllers. The output of the servo controller 512 is provided to the DAC interfaces 514A through 514N and converted to suitable correction signal (e.g. a DC voltage or a radiofrequency correction signal) by DACs 516A through 516N. The output of DACs 516A through 516N is then provided to suitable laser actuators, e.g. the actuators of the laser systems 302 of FIGS. 3B through 3D.

FIG. 5A provides an embodiment in which the components of digital locking electronics 314 include two direct digital synthesizers, i.e. DDS1 518 and DDS2 520. DDS1 518 is configured to generate a signal for driving the optical phase modulator 304, while DDS2 is configured to generate a signal for use by analog demodulation and gain shaping network 316 in demodulating the analog branch radiofrequency electrical input signal. In standard PDH operation, DDS1 518 is configured to generate a waveform for driving the optical phase modulator 304 that has the form A·sin(2πΩ_{PDH}t), while in offset locking operation, DDS1 518 is configured to generate a waveform for driving the optical phase modulator 304 that has the form A·sin(2πΔt+β sin(2πΩ_{PDH}t)). In both modes of operation, DDS2 520 is configured to generate a waveform of the form B·sin(2πΩ_{PDH}t+ϕ_{demod}), which is used for demodulating, by the analog demodulation and gain shaping network 316, the analog branch radiofrequency electrical input signal.

FIG. 5B provides an embodiment in which the components of digital locking electronics 314 are identical to those illustrated in FIG. 5A. However, FIG. 5B contemplates an embodiment of a hybrid PDH laser frequency stabilization system configured for dual frequency PDH operation. In order to provide for dual frequency standard PDH operation, DDS1 518 is configured to generate a waveform for driving the optical phase modulator 304 that has the form A·sin(2πΩ_{digital}t)+B·sin(2πΩ_{analog}t), while for providing dual frequency offset locking operation, DDS1 518 is configured to generate a waveform for driving the optical phase modulator 304 that has the form A·sin(2πΔt+β sin(2πΩ_{digital}t)+γ sin(2πΩ_{analog}t)). In both modes of operation, DDS2 520 is configured to generate a waveform of the form B·sin(2πΩ_{analog}t+ϕ_{demod}), which is used for demodulating, by the analog demodulation and gain shaping network 316, the analog branch radiofrequency electrical input signal.

FIG. 5C provides an embodiment in which the components of digital locking electronics 314 additionally include DDS3 522 and signal summer 524. Like the embodiment illustrated in FIG. 5B, the embodiment of FIG. 5C also contemplates dual frequency PDH operation. However, instead of digitally summing a representation of a digital PDH frequency and an analog PDH frequency (as is implicit in the embodiment of FIG. 5B and as is illustrated in FIG. 3E), the embodiment of FIG. 5C contemplates an additional DDS (i.e. DDS3 522) to generate an analog signal and a signal summer that sums the signals generated by DDS1 518 and DDS3 522 to produce a summed signal for driving the optical phase modulator 304. In order to provide for dual frequency standard PDH operation, DDS1 518 is configured to generate a waveform that has the form A sin(2πΩ_{digital}t), DDS3 522 is configured to generate a waveform that has the form C sin(2πΩ_{analog}t), and DDS2 520 is configured to generate a waveform that has the form B sin(2πΩ_{analog}t+ϕ_{demod}).

FIG. 5D provides an embodiment in which the components of digital locking electronics 314 include DDS3 522 and in which it is contemplated that the outputs of both DDS1 518 and DDS3 522 will drive a separate EOM of optical phase modulator 304. In the embodiment of FIG. 5D, to provide for dual frequency standard PDH operation, DDS1 518 is configured to generate a waveform for driving a first EOM of optical phase modulator 304 that has the form A·sin(2πΩ_{digital}t), and DDS3 522 is configured to generate a waveform for driving a second EOM of optical phase modulator 304 that has the form C sin(2πΩ_{analog}t). For providing dual frequency offset locking operation, DDS1 518 is configured to generate a waveform for driving a first EOM of optical phase modulator 304 that has the form A·sin(2πΔt+β sin(2πΩ_{digital}t)), while DDS3 522 is configured to generate a waveform for driving a second EOM of optical phase modulator 304 that has a form C·sin(2πΩ_{analog}t). In both modes of operation, DDS2 520 is configured to generate a waveform of the form B·sin(2πΩ_{analog}t+ϕ_{demod}).

In the digital circuitry illustrated in FIGS. 5A through 5D, the digital demodulation circuitry 500 additionally includes a phase detector 526, which is configured to detect a phase of the output of DDS2 520, and a tunable phase shifter 528, which is configured to set the phase (i.e. ϕ_{demod}) of the digital representation of the signal output by DDS2 520. The tunable phase shifter 528 receives a digital representation, from ADC 530, of the output of DDS2 520 via coupler/splitter 532. The combination of phase detector 526 and tunable phase setter 528 makes it possible to select a phase for the output of DDS2 that optimizes performance of the analog demodulation and gain shaping network 316.

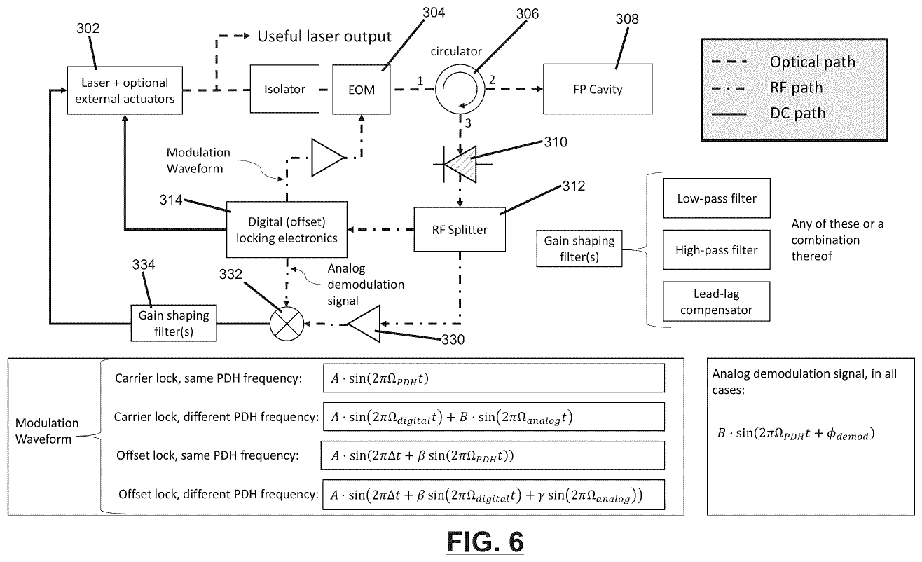

FIG. 6 illustrates a general architecture for a PDH laser frequency stabilization system, which includes a digital control branch and an analog control branch, that utilizes hybrid circuitry to process a feedback signal and generate control signals for stabilizing the output frequency of a laser beam. Many components of the general architecture of FIG. 6 are identical to those of FIGS. 3A through 3E, and the same reference numerals used in FIGS. 3A through 3E are used in FIG. 6 to identify the identical components.

FIG. 6 illustrates a general architecture similar to that of FIG. 3A, but includes additional detail concerning the individual analog circuitry of the analog demodulation and gain shaping network 316. Specifically, the architecture of FIG. 6 includes, in the analog demodulation and gain shaping network 316 an amplifier 330, an analog mixer 332, and gain shaping filters 334. The gain shaping filters 334 can include any one of a low-pass filter, a high-pass filter, or a lead-lag compensator, or any combination of two or more of said low-pass filter, high-pass filter, and lead-lag compensator. The analog mixer 332 receives an analog demodulation signal from the digital locking electronics 314. Said analog demodulation signal has, in all modes of operation, the form B·sin(2πΩ_{analog} t+ϕ_{demod}). Said analog demodulation signal can be provided, for example, by DDS2 520 of any of the embodiments of FIGS. 5A through 5D.

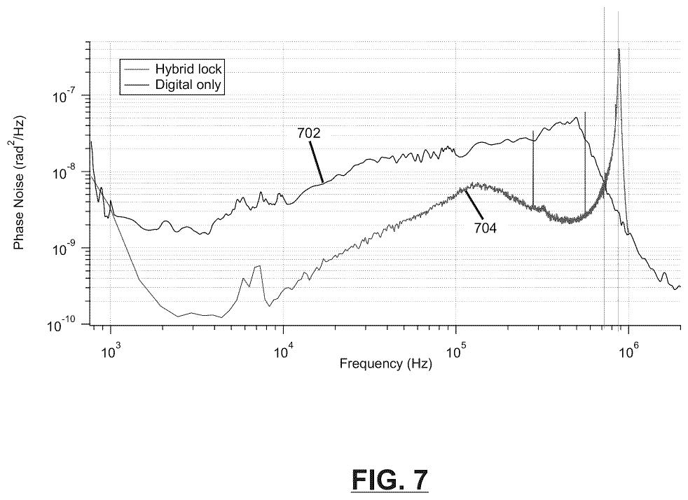

FIG. 7 provides a comparison of (i) a laser noise output spectrum of a laser frequency stabilized by a digital PDH laser frequency stabilization system 702 and (ii) a laser noise output spectrum of a laser that is frequency stabilized by a hybrid PDH laser frequency stabilization system 704 according to an embodiment of the disclosure. As can be seen in FIG. 7, the use of a hybrid PDH laser frequency stabilization system provides a substantial reduction in phase noise present in an emitted laser beam as compared to a digital PDH laser frequency stabilization system. In particular, phase noise as frequencies between 1 kHz and approximately 700 kHz are substantially reduced through the use of the hybrid PDH laser frequency stabilization system as compared with a purely digital PDH laser frequency stabilization system. Notably, the feedback loop that produced the laser noise output spectrum for the hybrid PDH laser frequency stabilization system in FIG. 7 was driven near oscillation that generated a spike noise at approximately 900 kHz. Although such a spike is generally undesirable, it may be more or less impactful depending on the specific application for which the laser is used. Furthermore, improvements in the bandwidth of the noise reduction could potentially be achieved through the use of alternative actuators. In the feedback loop that produced the laser noise output spectrum for the hybrid PDH laser frequency stabilization system in FIG. 7, the hybrid PDH laser frequency stabilization system was used to control the current provided to an external cavity laser diode. Further improvements to the bandwidth could potentially be achieved, e.g., through the use of an EOM. Ultimately, the limits to the noise reduction attainable through hybrid PDH laser frequency stabilization will depend on (i) time delays in the various components of the system, and (ii) the information carrying capacity of the PDH wave. Generally, information can be conveyed within a few cycles of the PDH frequency, so if the PDH frequency is on the order of 10 MHz, this it is likely that the servo limit may be on the order of 2-3 MHz. Furthermore, as a result of the aforementioned limitation, it is optimal to implement dual frequency PDH with Ω_{analog}>Ω_{digital}.

### CERTAIN ASPECTS AND EMBODIMENTS

Various aspects are contemplated and disclosed herein, several of which are set forth in the paragraphs below. It is explicitly contemplated and disclosed that any aspect or portion thereof can be combined to form an aspect. For example, it is contemplated and disclosed that, optionally, any system, component, device, feature, method, or step of any the below aspects may be useful with or combined with any other aspect provided below. Further, for example, it is contemplated and disclosed that any embodiment or aspect described above may, optionally, be combined with any of the below listed aspects.

Aspect 1: A laser stabilization system for stabilizing a laser beam emitted by a laser at a target frequency, the laser stabilization system comprising:
a phase modulator configured to receive laser radiation provided by the laser, to apply a phase modulation to the received laser radiation, and to provide, as output, phase modulated laser radiation;
an optical cavity configured to receive the phase modulated laser radiation and to provide amplitude modulated measurement radiation;
an optical detector configured to receive the amplitude modulated measurement radiation from the optical cavity and to generate, based on the received amplitude modulated measurement radiation, a radiofrequency electrical signal;
a signal distribution network configured to receive the radiofrequency electrical signal and to provide, based on the radiofrequency electrical signal, a digital branch electrical input signal and an analog branch electrical input signal;
a digital control circuit configured to receive the digital branch electrical input signal and to generate, based on the digital branch electrical input signal, a first control signal;
an analog control circuit configured to receive the analog branch electrical input signal and to generate, based on the analog branch electrical input signal, a second control signal; and
an output interface configured to supply laser control output to the laser based on the first control signal and the second control signal.

Aspect 2: The laser stabilization system of Aspect 1, wherein the signal distribution network comprises a splitter configured to split the radiofrequency electrical signal into the digital branch electrical input signal and the analog branch electrical input signal.

Aspect 3: The laser stabilization system of Aspect 1 or 2, further comprising:
the laser;
a beam splitter configured to extract, from the laser beam emitted by the laser, a laser beam component consisting of the laser radiation that the phase modulator is configured to receive.

Aspect 4: The laser stabilization system of any of Aspects 1-3, wherein the laser control output includes a first laser control component and a second laser control component, and wherein the output interface comprises:
a first actuator interface configured to supply the first control signal to a first actuator of the laser as the first laser control component, and
a second actuator interface configured to supply the second control signal to a second actuator of the laser as the second laser control component.

Aspect 5: The laser stabilization system of Aspect 4, wherein the first actuator is a piezo-electric transducer (PZT), and
wherein the second actuator is: an intra-cavity electro-optic modulator (EOM), an external EOM, an external acousto-optic modulator, or a diode current source.

Aspect 6: The laser stabilization system of any of Aspects 1-3, wherein the laser control output is a combined laser control signal that is a sum of the first control signal and the second control signal, and wherein the output interface comprises an actuator interface configured to supply the combined laser control signal to one or more actuators of the laser.

Aspect 7: The laser stabilization system of Aspect 6, wherein the one or more actuators include one or more of a piezo-electric transducer (PZT), an intra-cavity electro-optic modulator (EOM), an external EOM, an external acousto-optic modulator, or a diode current source.

Aspect 8: The laser stabilization system of any of Aspects 1-7, wherein the digital signal control circuit comprises:
an analog-to-digital converter (ADC) configured to convert the radiofrequency electrical signal into a digital time series;
a digital mixer configured to mix the time series of the radiofrequency electrical signal with a digital representation of the phase modulation applied by the phase modulator to the laser radiation to provide a demodulated digital error signal, wherein the digital representation of the phase modulation has a selectable phase shift relative to the phase modulation applied by the phase modulator;
a digital servo configured to convert the demodulated digital error signal into a digital output signal; and
a digital-to-analog converter (DAC) configured to generate the first control signal from the digital output signal.

Aspect 9: The laser stabilization system of any of Aspects 1-8, wherein the analog signal control circuit comprises:
an analog mixer configured to mix the second radiofrequency electrical signal with an electrical manifestation of a digital signal that represents the phase modulation applied by the phase modulator to the laser radiation to provide a mixed analog error signal, wherein the electrical manifestation of the digital signal that represents the phase modulation has a phase shift relative to the phase modulation applied by the phase modulator; and
an analog servo configured to generate the second control signal from the mixed analog error signal.

Aspect 10: The laser stabilization system of any of Aspects 1-9, wherein:
the phase modulator is configured to be driven by a phase modulated carrier signal, the carrier signal having a frequency equal to an offset frequency, and the digital signal control circuit is configured to generate the first control signal to control the laser to produce laser light at a frequency equal to a resonant frequency of the optical cavity plus or minus the offset frequency; and/or
a digital branch is configured to perform demodulation using a first PDH frequency and an analog branch is configured to perform demodulation using a second PDH frequency that is different from the first PDH frequency.

Aspect 11: A method for generating a control signal for tuning a laser beam emitted by a laser to a target frequency, the method comprising:
applying, by a phase modulator, a phase modulation to laser radiation output by the laser to produce phase modulated laser radiation;
directing the phase modulated laser radiation to an optical cavity;
providing, by the optical cavity from the phase modulated laser radiation, amplitude modulated measurement radiation;
directing the amplitude modulated measurement radiation to an optical detector;
generating, by the optical detector from the amplitude modulated measurement radiation, a radiofrequency electrical signal;
supplying, by a signal distribution network and based on the radiofrequency electrical signal, a digital branch electrical input signal and an analog branch electrical input signal;
generating, by a digital control circuit based on the digital branch electrical input signal, a first control signal;
generating, by an analog control circuit based on the analog branch electrical input signal, a second control signal; and
supplying, to the laser, laser control output for stabilizing the laser at the target frequency, wherein the laser control output is based on the first control signal and the second control signal.

Aspect 12: The method according to Aspect 11, wherein the supplying, by the signal distribution network, the digital branch electrical input signal and the analog branch electrical input signal comprises splitting, by a splitter, the radiofrequency electrical signal into the digital branch electrical input signal and the analog branch electrical input signal.

Aspect 13. The method according to Aspect 11 or 12, further comprising: extracting, by a beam splitter from the laser beam emitted by the laser, a laser beam component consisting of the laser radiation to which the phase modulator applies the phase modulation.

Aspect 14: The method according to any of Aspects 11-13, wherein the supplying the laser control output to the laser comprises:
supplying a first component signal of the laser control output to a first actuator of the laser; and
supplying a second component signal of the laser control output to a second actuator of the laser.

Aspect 15: The method according to Aspect 14, wherein the first actuator is a piezo-electric transducer (PZT), and
wherein the second actuator is: an intra-cavity electro-optic modulator (EOM), an external EOM, an external acousto-optic modulator, or a diode current source.

Aspect 16: The method according to any of Aspects 11-13, wherein the laser control output is a combined laser control signal that is a sum of the first control signal and the second control signal, and wherein the supplying the laser control output to the laser comprises supplying the combined laser control signal to one or more actuators of the laser.

Aspect 17: The method according to Aspect 16, wherein the one or more actuators include one or more of a piezo-electric transducer (PZT), an intra-cavity electro-optic modulator (EOM), an external EOM, an external acousto-optic modulator, or a diode current source.

Aspect 18: The method according to any of Aspects 11-17, wherein the generating, by the digital control circuit based on the digital branch electrical input signal, the first control signal comprises:
converting, by an analog-to-digital converter (ADC), the digital branch electrical input signal into a digital time series;
mixing, by a digital mixer, the digital time series with a digital representation of the phase modulation to provide a demodulated digital error signal, wherein the digital representation of the phase modulation has a selectable phase shift relative to the phase modulation applied by the phase modulator;
converting, by a digital servo, the demodulated digital error signal into a digital output signal; and
generating, by a digital-to-analog converter (DAC), the first control signal from the digital output signal.

Aspect 19: The method according to any of Aspects 11-18, wherein the generating, by the analog control circuit based on the analog branch electrical input signal, the second control signal comprises:
mixing, by an analog mixer, the analog branch electrical input signal with an electrical manifestation of a digital signal that represents the phase modulation to provide a mixed analog error signal, wherein the electrical manifestation of the digital signal that represents the phase modulation has a phase shift relative to the phase modulation applied by the phase modulator; and
generating, by an analog servo, the second control signal from the mixed analog error signal.

Aspect 20: The method according to any of Aspects 11-19, wherein:
the phase modulator is configured to be driven by a phase modulated carrier signal, the carrier signal having a frequency equal to an offset frequency, and the digital signal control circuit is configured to generate the first control signal to control the laser to produce laser light at a frequency equal to a resonant frequency of the optical cavity plus or minus the offset frequency; and/or
a digital branch is configured to perform demodulation using a first PDH frequency and an analog branch is configured to perform demodulation using a second PDH frequency that is different from the first PDH frequency.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

As used herein and in the appended claims, the singular forms “a”, “an”, and “the” include plural reference unless the context clearly dictates otherwise. Thus, for example, reference to “a optical source” includes a plurality of such optical sources and equivalents thereof known to those skilled in the art. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

What is claimed is:

1. A laser stabilization system for stabilizing a laser beam emitted by a laser at a target frequency, the laser stabilization system comprising:
a phase modulator configured to receive laser radiation provided by the laser, to apply a phase modulation to the received laser radiation, and to provide, as output, phase modulated laser radiation;
an optical cavity configured to receive the phase modulated laser radiation and to provide amplitude modulated measurement radiation;
an optical detector configured to receive the amplitude modulated measurement radiation from the optical cavity and to generate, based on the received amplitude modulated measurement radiation, a radiofrequency electrical signal;
a signal distribution network configured to receive the radiofrequency electrical signal and to provide, based on the radiofrequency electrical signal, a digital branch electrical input signal and an analog branch electrical input signal;
a digital control circuit configured to receive the digital branch electrical input signal and to generate, based on the digital branch electrical input signal, a first control signal;
an analog control circuit configured to receive the analog branch electrical input signal and to generate, based on the analog branch electrical input signal, a second control signal; and
an output interface configured to supply laser control output to the laser based on the first control signal and the second control signal.

2. The laser stabilization system of claim 1, wherein the signal distribution network comprises a splitter configured to split the radiofrequency electrical signal into the digital branch electrical input signal and the analog branch electrical input signal.

3. The laser stabilization system of claim 1, further comprising:
the laser,
a beam splitter configured to extract, from the laser beam emitted by the laser, a laser beam component consisting of the laser radiation that the phase modulator is configured to receive.

4. The laser stabilization system of claim 1, wherein the laser control output includes a first laser control component and a second laser control component, and wherein the output interface comprises:
a first actuator interface configured to supply the first control signal to a first actuator of the laser as the first laser control component, and
a second actuator interface configured to supply the second control signal to a second actuator of the laser as the second laser control component.

5. The laser stabilization system of claim 4, wherein the first actuator is a piezo-electric transducer (PZT), and
wherein the second actuator is: an intra-cavity electro-optic modulator (EOM), an external EOM, an external acousto-optic modulator, or a diode current source.

6. The laser stabilization system of claim 1, wherein the laser control output is a combined laser control signal that is a sum of the first control signal and the second control signal, and wherein the output interface comprises an actuator interface configured to supply the combined laser control signal to one or more actuators of the laser.

7. The laser stabilization system of claim 6, wherein the one or more actuators include one or more of a piezo-electric transducer (PZT), an intra-cavity electro-optic modulator (EOM), an external EOM, an external acousto-optic modulator, or a diode current source.

8. The laser stabilization system of claim 1, wherein the digital signal control circuit comprises:
an analog-to-digital converter (ADC) configured to convert the radiofrequency electrical signal into a digital time series;
a digital mixer configured to mix the time series of the radiofrequency electrical signal with a digital representation of the phase modulation applied by the phase modulator to the laser radiation to provide a demodulated digital error signal, wherein the digital representation of the phase modulation has a selectable phase shift relative to the phase modulation applied by the phase modulator;
a digital servo configured to convert the demodulated digital error signal into a digital output signal; and
a digital-to-analog converter (DAC) configured to generate the first control signal from the digital output signal.

9. The laser stabilization system of claim 1, wherein the analog signal control circuit comprises:
an analog mixer configured to mix the second radiofrequency electrical signal with an electrical manifestation of a digital signal that represents the phase modulation applied by the phase modulator to the laser radiation to provide a mixed analog error signal, wherein the electrical manifestation of the digital signal that represents the phase modulation has a phase shift relative to the phase modulation applied by the phase modulator; and
an analog servo configured to generate the second control signal from the mixed analog error signal.

10. The laser stabilization system of claim 1, wherein:
the phase modulator is configured to be driven by a phase modulated carrier signal, the carrier signal having a frequency equal to an offset frequency, and the digital signal control circuit is configured to generate the first control signal to control the laser to produce laser light at a frequency equal to a resonant frequency of the optical cavity plus or minus the offset frequency; and/or
a digital branch is configured to perform demodulation using a first PDH frequency and an analog branch is configured to perform demodulation using a second PDH frequency that is different from the first PDH frequency.

11. A method for generating a control signal for tuning a laser beam emitted by a laser to a target frequency, the method comprising:
applying, by a phase modulator, a phase modulation to laser radiation output by the laser to produce phase modulated laser radiation;
directing the phase modulated laser radiation to an optical cavity;
providing, by the optical cavity from the phase modulated laser radiation, amplitude modulated measurement radiation;
directing the amplitude modulated measurement radiation to an optical detector;
generating, by the optical detector from the amplitude modulated measurement radiation, a radiofrequency electrical signal;
supplying, by a signal distribution network and based on the radiofrequency electrical signal, a digital branch electrical input signal and an analog branch electrical input signal;
generating, by a digital control circuit based on the digital branch electrical input signal, a first control signal;
generating, by an analog control circuit based on the analog branch electrical input signal, a second control signal; and
supplying, to the laser, laser control output for stabilizing the laser at the target frequency, wherein the laser control output is based on the first control signal and the second control signal.

12. The method according to claim 11, wherein the supplying, by the signal distribution network, the digital branch electrical input signal and the analog branch electrical input signal comprises splitting, by a splitter, the radiofrequency electrical signal into the digital branch electrical input signal and the analog branch electrical input signal.

13. The method according to claim 11, further comprising:
extracting, by a beam splitter from the laser beam emitted by the laser, a laser beam component consisting of the laser radiation to which the phase modulator applies the phase modulation.

14. The method according to claim 11, wherein the supplying the laser control output to the laser comprises:
supplying a first component signal of the laser control output to a first actuator of the laser; and
supplying a second component signal of the laser control output to a second actuator of the laser.

15. The method according to claim 14, wherein the first actuator is a piezo-electric transducer (PZT), and
wherein the second actuator is: an intra-cavity electro-optic modulator (EOM), an external EOM, an external acousto-optic modulator, or a diode current source.

16. The method according to claim 11, wherein the laser control output is a combined laser control signal that is a sum of the first control signal and the second control signal, and wherein the supplying the laser control output to the laser comprises supplying the combined laser control signal to one or more actuators of the laser.

17. The method according to claim 16, wherein the one or more actuators include one or more of a piezo-electric transducer (PZT), an intra-cavity electro-optic modulator (EOM), an external EOM, an external acousto-optic modulator, or a diode current source.

18. The method according to claim 11, wherein the generating, by the digital control circuit based on the digital branch electrical input signal, the first control signal comprises:
converting, by an analog-to-digital converter (ADC), the digital branch electrical input signal into a digital time series;
mixing, by a digital mixer, the digital time series with a digital representation of the phase modulation to provide a demodulated digital error signal, wherein the digital representation of the phase modulation has a selectable phase shift relative to the phase modulation applied by the phase modulator;
converting, by a digital servo, the demodulated digital error signal into a digital output signal; and
generating, by a digital-to-analog converter (DAC), the first control signal from the digital output signal.

19. The method according to claim 11, wherein the generating, by the analog control circuit based on the analog branch electrical input signal, the second control signal comprises:
mixing, by an analog mixer, the analog branch electrical input signal with an electrical manifestation of a digital signal that represents the phase modulation to provide a mixed analog error signal, wherein the electrical manifestation of the digital signal that represents the phase modulation has a phase shift relative to the phase modulation applied by the phase modulator; and
generating, by an analog servo, the second control signal from the mixed analog error signal.

20. The method according to claim 11, wherein:
the phase modulator is configured to be driven by a phase modulated carrier signal, the carrier signal having a frequency equal to an offset frequency, and the digital signal control circuit is configured to generate the first control signal to control the laser to produce laser light at a frequency equal to a resonant frequency of the optical cavity plus or minus the offset frequency; and/or
a digital branch is configured to perform demodulation using a first PDH frequency and an analog branch is configured to perform demodulation using a second PDH frequency that is different from the first PDH frequency.
